(19) United States
(12) Patent Application Publication
(10) Pub. No.: US 2016/0086283 A1
(43) Pub. Date: Mar. 24, 2016

(54) System for Analyzing Patient Out-of-Network Utilization and Improving Retention

(71) Applicant: Aetna Inc., Hartford, CT (US)

(72) Inventors: Royal Tuthill, Sea Cliff, NY (US); Kristen Coletto, New York, NY (US); Chad Allen, San Francisco, CA (US)

(21) Appl. No.: 14/490,111

(22) Filed: Sep. 18, 2014

(51) Int. Cl. G06Q 40/08; G06Q 50/22; G06Q 10/06

(52) U.S. Cl. CPC G06Q 40/08; G06Q 10/063; G06Q 50/22

(57) ABSTRACT

A patient out-of-network utilization analysis and reporting system includes: an out-of-network utilization analysis server, configured to access one or more databases to obtain healthcare claims information, to generate out-of-network utilization analysis information corresponding to identification of potential sources of patient out-of-network utilization based on the obtained healthcare claims information, and to the send out-of-network utilization analysis information to a client computing device, wherein the healthcare claims information includes procedure-related information and/or physician attribution information; and the client computing device, configured to receive out-of-network utilization analysis information via a network from a server and to display the out-of-network utilization analysis information to a user of the client computing device.

### BACKGROUND

For healthcare provider organizations—such as Accountable Care Organizations (ACOS) which include a group of doctors and/or hospitals that assume responsibility for quality and cost of health care for a defined set of patients, as well as other providers such as non-ACO hospital/physician groups, large employers, and insurance providers—patient out-of-network utilization (where patients go outside of the provider organization's network for healthcare services) is a significant concern. On average, provider organizations experience 40% to 80% patient out-of-network utilization rates, which results in significant lost revenue, increased costs for the patient, potentially decreased quality of care for the patient, and gaps in patient health data.

A conventional method of attempting to identify out-of-network utilization and improve retention is to look at macro trends in the patient population by obtaining de-identified claims data from payors. However, this method provides only a very general indication regarding the occurrence of out-of-network utilization, and is unable to provide specific information at the patient and claim level.

### SUMMARY

Embodiments of the invention provide systems and methods by which a provider organization (e.g., ACO, non-ACO groups, employers, healthcare insurance and plan providers, etc.) is able to better understand patient out-of-network utilization and leverage that understanding to increase patient retention. In an exemplary embodiment, the invention provides a healthcare analysis system, accessible by remote computing devices to provide an interactive interface to allow different types of users (e.g., provider administrators, hospital administrators, physicians, etc.) to determine specific details regarding patient out-of-network utilization in a manner that will help them to, for example: quantify patient out-of-network utilization/retention, determine where out-of-network utilization is occurring (e.g., by service line, physician, health plan, etc.), determine opportunities to improve patient retention, identify where leaked patients are going for out-of-network services, improve physician awareness, and obtain detailed patient and claim level information.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram illustrating an exemplary environment for a networked system in an embodiment.

FIG. 2 is a block diagram illustrating elements of FIG. 1 in greater detail.

FIGS. 3 and 4 are flowcharts illustrating exemplary processes for patient out-of-network utilization analysis in exemplary embodiments.

FIGS. 5-11 are exemplary screens illustrating a user interface for reporting patient out-of-network utilization-related information.

### DETAILED DESCRIPTION

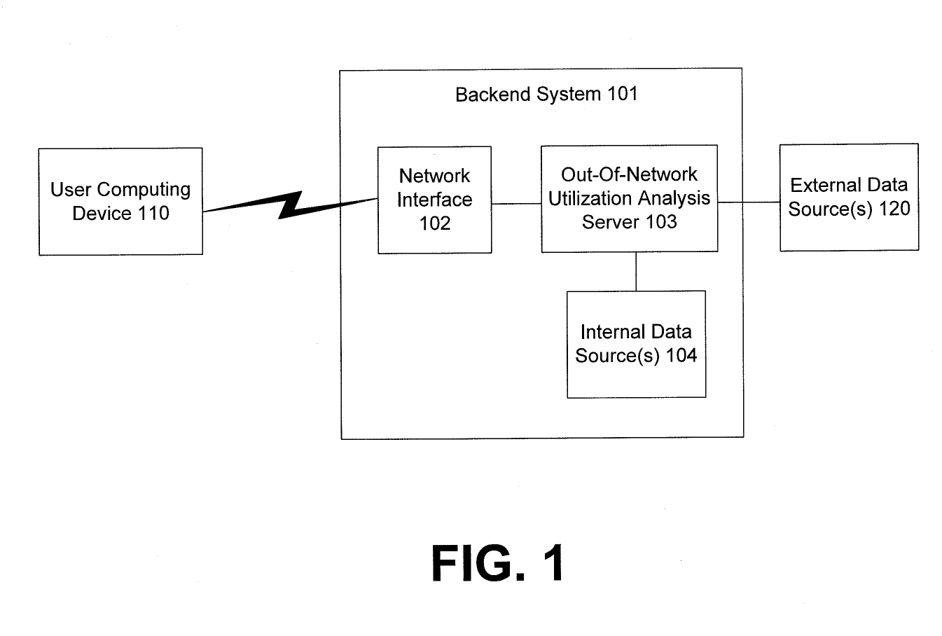

FIG. 1 is a block diagram illustrating an exemplary environment suitable for implementing embodiments of the invention. The environment includes a backend system 101 having a network interface 102 (e.g., a web server) through which remote computing devices such as user computing device 110 (e.g., a personal computer, laptop, tablet, smartphone, etc.) can connect to components of the backend system 101. The backend system 101 further includes an out-of-network utilization analysis server 103 (e.g., a specifically-configured application server) for providing out-of-network utilization analytics and generating information reports, and may further include one or more internal data sources 104 (e.g., databases or other servers connected to databases that pre-process the information from the databases) and/or connections to one or more external data sources 120 (e.g., third-party databases from other provider organizations or medical record-keeping organizations) for retrieving claims information. The user computing device 110 is connected to the backend system 101 via a communications network such as through the Internet, utilizing wireless and/or wired connections such as local area network (LAN) protocols, wireless local area network (WLAN) protocols, cellular protocols, etc.

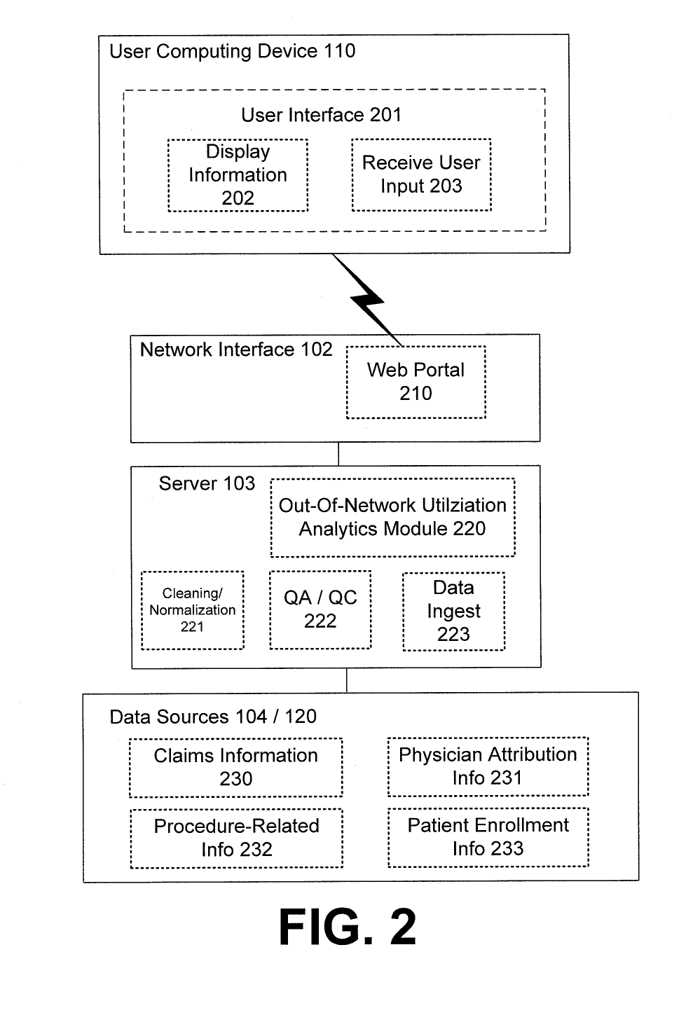

FIG. 2 is a block diagram illustrating in further detail the elements depicted in FIG. 1 and certain functionality corresponding thereto. The user computing device 110 includes a user interface 201 for displaying information 202 (for example, data visualization graphs, reports, and/or maps) based on the patient out-of-network utilization analysis performed by the system backend and for providing inputs 203 to navigate the tool so as to apply different filters and/or present different analyses. In one exemplary implementation, this user interface 201 may be provided, for example, via a browser application installed on the user computing device 110, which displays information generated by the backend system. In another exemplary implementation, this user interface 201 may be provided, for example, via a specific analytics application installed on the user computing device 110, with functionality (such as report generation) being provided by the specific analytics application such that the backend system 101 simply provides data to the user computing device 110 in response to queries by the user computing device, or such that both the user computing device 110 and the backend system 101 perform aspects of generating and formatting the information to be displayed on the user computing device 110.

The backend system 101 provides a network interface 102, which may include a web server configured to provide a web portal 210. The network interface 102 connects the user computing device 110 to the server 103, allowing the user computing device 110 to request and receive information processed by the server 103 (as discussed above, this information may or may not be formatted into an appropriate reporting format prior to reception by the user computing device 110). The server 103 includes an out-of-network utilization analytics module 220, which executes logic (e.g., according to processor-executable instructions stored on a non-transitory computer-readable medium corresponding to the server 103) to process claims information to identify and analyze potential sources of patient out-of-network utilization. The server 103 further includes modules for cleaning and normalization 221, quality assurance and quality control 222, and data ingest 223.

The data ingest module 223 of the server 103 provides an interface for the server 103 to receive claims information and other information from internal and external data sources 104/120. These data sources may include claims information 230, as well as processed claims information (for example, claims information for which additional fields, e.g., pertaining to procedure categorization or physician attribution, have been added). In an exemplary implementation, the information received by the server 103 from the data sources 104/120 further includes physician attribution information 231 (i.e., identifications of the primary physician associated with each claim), and procedure identification and/or categorization information 232. In one particular example, the procedure identification and/or categorization information 232 includes identifications of the specific procedures associated with each claim, as well as identifications of the procedure group, category, and class of each claim—e.g., with over 10,000 procedure identifications are categorized into “major,” “minor,” “diagnostic,” or “other” procedure “classes, with further divisions into 21 procedure categories and 176 procedure groups. The data sources 104/120 may further include patient enrollment information 233, which provides information about patient participation, the patient's address, and other demographic information, and which can be correlated with claims information, for example, based on a patient identification number.

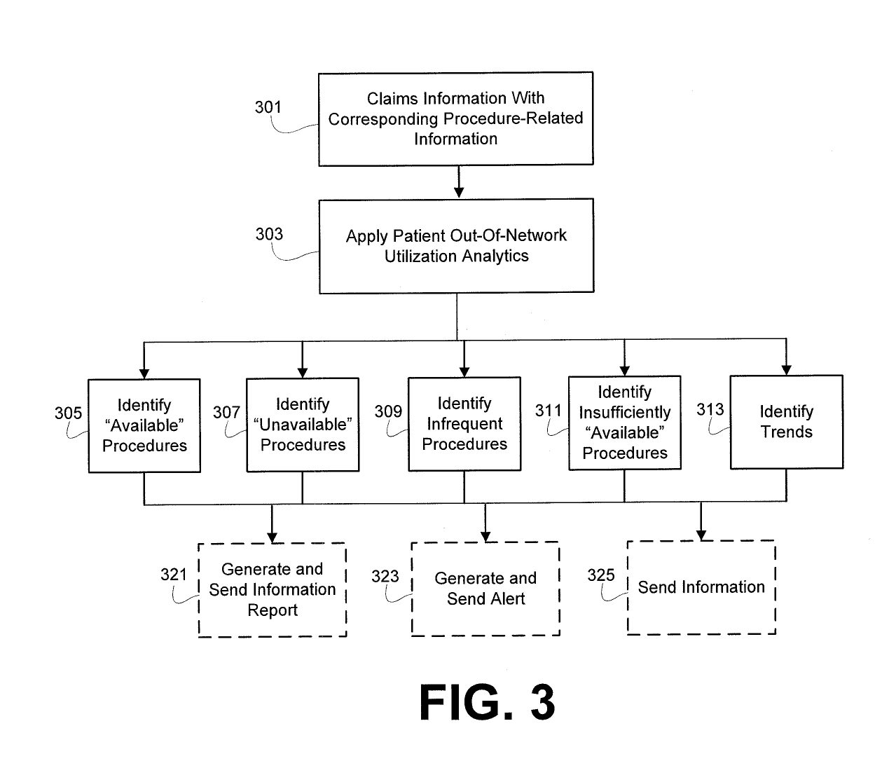

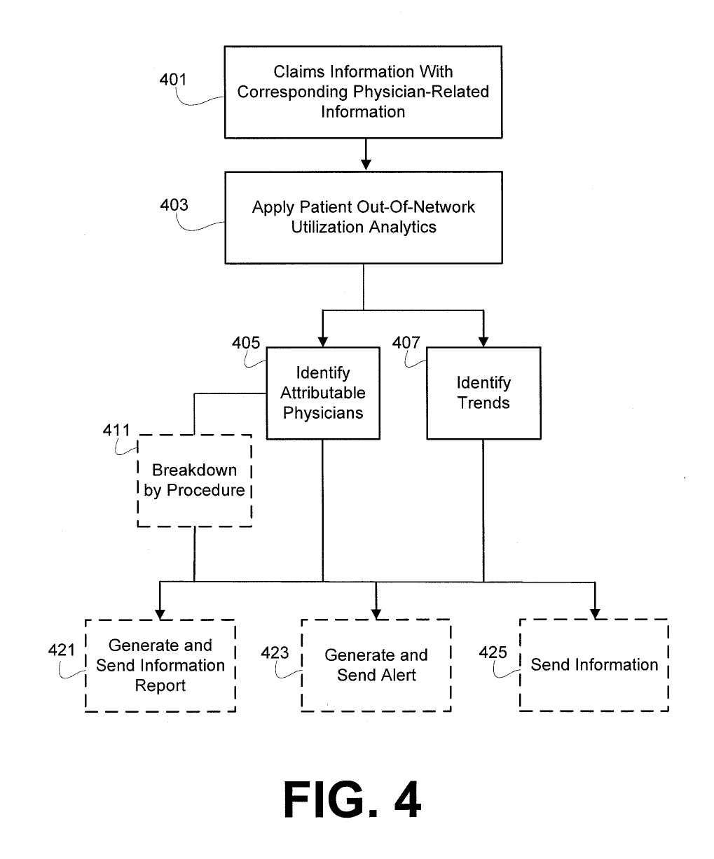

FIGS. 3-4 are flowcharts illustrating exemplary out-of-network utilization analyses that can be performed by out-of-network utilization analytics module 220 to identify sources of patient out-of-network utilization with particularity.

FIG. 3 illustrates a process for identifying whether patient out-of-network utilization might be due to a scarcity or lack of a particular type of medical procedure within a healthcare provider's network is a likely cause of patient out-of-network utilization. At stage 301, the out-of-network utilization analytics module obtains or accesses claims information from one or more data sources with corresponding procedure identification and/or categorization information. In an exemplary embodiment, at stage 303, the out-of-network utilization analytics module then analyzes the information to determine whether patients have been able to obtain particular procedures (or, e.g., procedure groups, categories, or classes) in-network above a threshold amount (the threshold amount may be, for example, a number of in-network procedures or a ratio or percentage of in-network procedures relative to out-of-network procedures or total number of procedures).

If so, the procedures (or, e.g., procedure groups, categories or classes) may be designated as “available” (or “offered”) in-network (stage 305), and if not, the procedures (or, e.g., procedure groups, categories or classes) may be designated as “unavailable” (or “not offered”) in-network (stage 307). This allows reports to be generated regarding which procedures are available and which are not available within the healthcare provider's network, allowing an administrator of the healthcare provider to determine whether to flag instances of out-of-network utilization (e.g., “appropriate” out-of-network utilization that is not flagged could be a patient going out-of-network for a non-offered service, while “inappropriate” out-of-network utilization that is flagged is a patient going out-of-network for an offered service). This further enables the administrator to take appropriate remedial action if needed.

In a further exemplary embodiment, before designating procedures as “available” or “unavailable,” the analysis at stage 303 further considers the amount of out-of-network performances of a procedure (or, e.g., procedure group, category or class) for patients of the health provider's network, and/or that amount in relation to the amount of in-network performances of a procedure (or, e.g., procedure group, category or class) for patients of the health provider's network. These considerations allow the system to determine that a procedure (or, e.g., procedure group, category or class) that is not performed might not necessarily be unavailable in-network (since patients are not going out-of-network for that procedure (or group, category or class) either) (stage 309). These considerations further allow the system to determine whether a procedure (or, e.g., procedure group, category or class) that meets the criteria for being available in-network is still nonetheless a source of patient out-of-network utilization because a large number of patients are also going out-of-network for that procedure (or, e.g., procedure group, category or class) (stage 311). This determination may, for example, be based on the absolute number of patients going out-of-network for that procedure (or, e.g., procedure group, category or class), or may be based on an out-of-network percentage or ratio.

The analysis at stage 303 may be limited to data for a certain time period (e.g., within the past year), if desired, to ensure that the results of the determination are up-to-date. Further, the analysis at stage 303 may identify trends in in-network and/or out-of-network performance of procedures (or, e.g., procedure groups, categories or classes) (stage 313). For example, if over the course of one or two years, or over the course of several months, the ratio of out-of-network performances of a procedure (or, e.g., procedure group, category or class) to in-network performances of that procedure (or, e.g., procedure group, category or class) is increasing, the system identifies the trend and notifies a user that out-of-network utilization is increasing for that procedure (or, e.g., procedure group, category or class).

The process depicted in FIG. 3 may be performed in an on-demand manner—for example, with respect to a user request for an overall summary of information with respect to procedures (or, e.g., procedure groups, categories, or classes) or with respect to a specific user request for particular information with respect to a particular procedure (or, e.g., procedure group, category or class)—to generate a report for a user (stage 321), for example, including graphical and other formats for presentation of the information, and further including interactive elements to allow users to further filter the information presented and query additional details.

The process depicted in FIG. 3 may also be performed in an ongoing manner, with the system monitoring claims information over a time window to identify potentially negative trends (such as an increase in out-of-network performances, a decrease in in-network availability) or triggers (such as out-of-network performances rising over a threshold or in-network performances falling below a threshold) to generate alerts for a user (stage 323).

As discussed above with respect to FIGS. 1 and 2, the report and/or alert generation functionality may be performed by the server, or alternatively may be fully or partially offloaded from the server-side to the client-side user computing device, with unformatted or partially formatted information being sent to the user computer device (stage 325).

FIG. 4 illustrates a process for identifying whether patient out-of-network utilization might be attributable to a particular in-network physician (which may be due to that physician making numerous out-of-network referrals or due to other reasons which may be outside of the physician's control) or to a group of in-network physicians. At stage 401, the out-of-network utilization analytics module obtains or accesses claims information with corresponding physician attribution information. In an exemplary embodiment, at stage 403, the out-of-network utilization analytics module then analyzes the data to determine whether particular physicians are associated with a large amount of out-of-network utilization or a high percentage of out-of-network utilization. This allows reports to be generated regarding which in-network physicians might be associated with patient out-of-network utilization, allowing an administrator of the healthcare provider and/or the physician to investigate and take appropriate remedial action if needed.

Similar to the discussion above with respect to stage 303 of FIG. 3, the analysis at stage 403 may be limited to a particular time period, may be used to identify trends (stage 405), and may be implemented on an on-demand or ongoing manner, with reports and alerts being generated (stages 421 and 423). The information may also be sent in an unformatted or partially-formatted form (stage 425). In a further exemplary embodiment, the procedure-related data discussed above with respect to FIG. 3 is also used with respect to the process of FIG. 4 to further determine whether particular in-network physicians are associated with out-of-network utilization in general or within the context of only specific procedures (or, e.g., procedure groups, categories or classes) (stage 411).

The processes discussed above with respect to FIGS. 3 and 4 may also be used in connection with other claims information to identify sources of out-of-network utilization relating to other parameters and fields of the claims information. For example, instead of or in addition to analyzing out-of-network utilization corresponding to physicians at stage 403 of FIG. 4, an analysis may be performed with respect to health plans corresponding to claims information to identify whether certain health plans are associated with patient out-of-network utilization (e.g., due to unavailability of services, payor type, benefit design, or other reasons such as pricing). Similarly, other parameters such as location of services facilities or physician offices, lack of capacity or quality of services for particular specialties (e.g., in general or relative to patient demand), and/or cost of services can be considered under the same analytics framework to identify possible correlations between such parameters and patient out-of-network utilization.

The processes in FIGS. 3-4 can also be adapted to additionally provide for identification of which out-of-network providers are providing healthcare services to in-network patients (e.g., based on the out-of-network physicians treating those patients). Knowing which out-of-network providers patients—as well as their geographic locations relative to in-network providers and patients—is useful to a healthcare administrator (e.g., an ACO, hospital, or other provider) to evaluate their in-network coverage and to determine how to improve patient retention. Such evaluations may be based on trend information (e.g., trends in how many patients, services, dollars received by an out-of-network provider from certain in-network providers and/or the types of procedures received by the out-of-network provider from in-network patients) similar to the trend information discussed above with respect to FIGS. 3 and 4.

Thus, the out-of-network utilization analytics module of this system provides a flexible and robust tool with which a health provider administrator or other user can effectively identify potential sources of patient out-of-network utilization with particularity, putting them into a better position to quickly and effectively redress any identified issues.

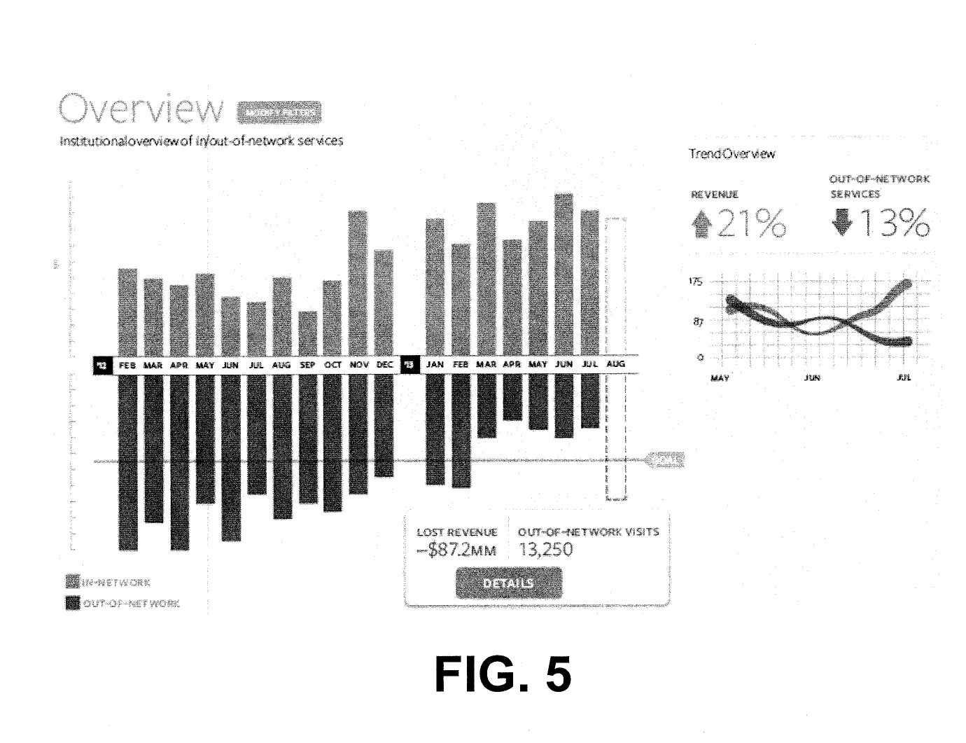

FIGS. 5-11 are exemplary screens illustrating a user interface presented to the user of a user computing device for reporting patient out-of-network utilization-related information.

FIG. 5 illustrates an exemplary overview reporting screen, which shows revenue from in-network patient visits (top half of the bar graph) versus lost revenue attributable to out-of-network utilization (i.e., “out-of-network patient visits) (bottom half of the bar graph) on a month-by-month basis. Trend information is also presented on the right side of the screen, indicating an increase in in-network revenue and a decrease in out-of-network services provided.

The screen is also interactive, allowing a user to select (e.g., by clicking a mouse or tapping a touchscreen) an area of the screen to provide more detailed information—particularly, FIG. 5 depicts that the out-of-network bar for February 2013 has been selected, and a particular dollar amount of “Lost Revenue” and number of out-of-network visits for that month is displayed with a further option of selecting the “Details” button for even more information. The screen also allows for filtering of the data presented by selecting the “Modify Filters” option, which brings up a variety of settings that are configurable by a user (e.g., to display data pertaining to: managed patients or fee-for-service patients or both; employed physicians or affiliated physicians or both; offered services or non-offered services or both; a specified timeframe; specified institutions, groups, or entities; etc.).

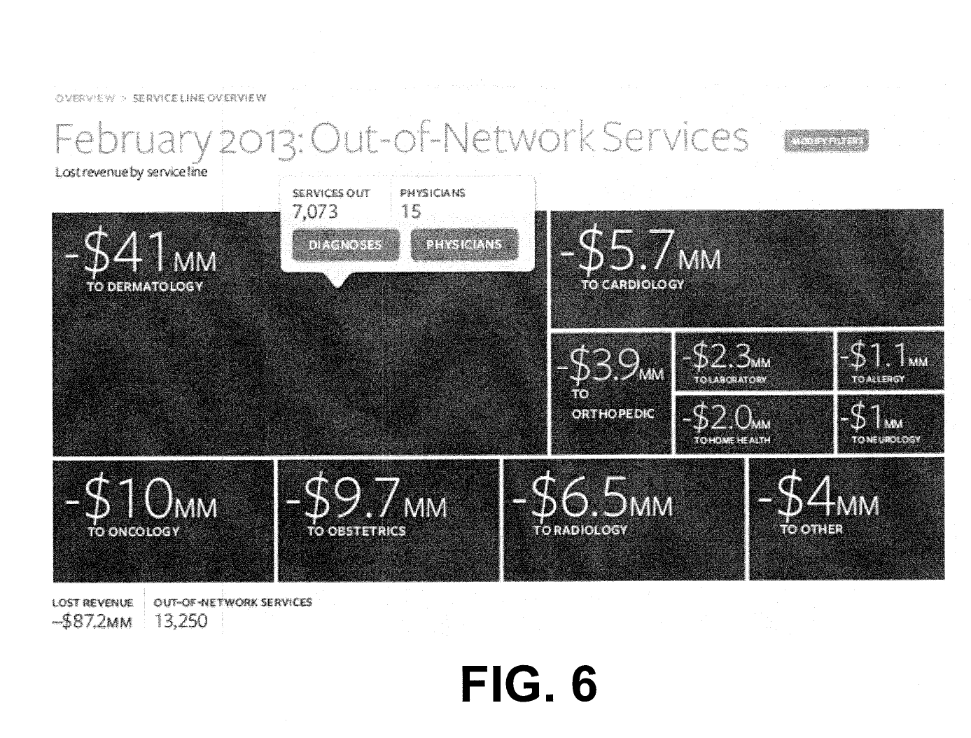

FIG. 6 illustrates a screen that is presented to the user after the user selects the “Details” button shown in FIG. 5 corresponding to out-of-network services from February 2013. In this example, a detailed breakdown of lost revenue by “service line” (e.g., a category of medical procedures) is given, showing the particular amount of lost revenue corresponding to out-of-network services from each of a plurality of service lines. This information is obtained, for example, via the patient out-of-network utilization analysis discussed above with respect to FIG. 3.

Further, in the example provided by FIG. 6, the user has selected the “—$41MM to Dermatology” area of the screen to obtain more information, showing that in the Dermatology service line, there were 7,073 out-of-network services performed in February 2013 and that 15 in-network physicians had attributed patients that went out-of-network for services. Further selecting the “Diagnoses” or “Physicians” buttons presents a new screen to the user with even further detail.

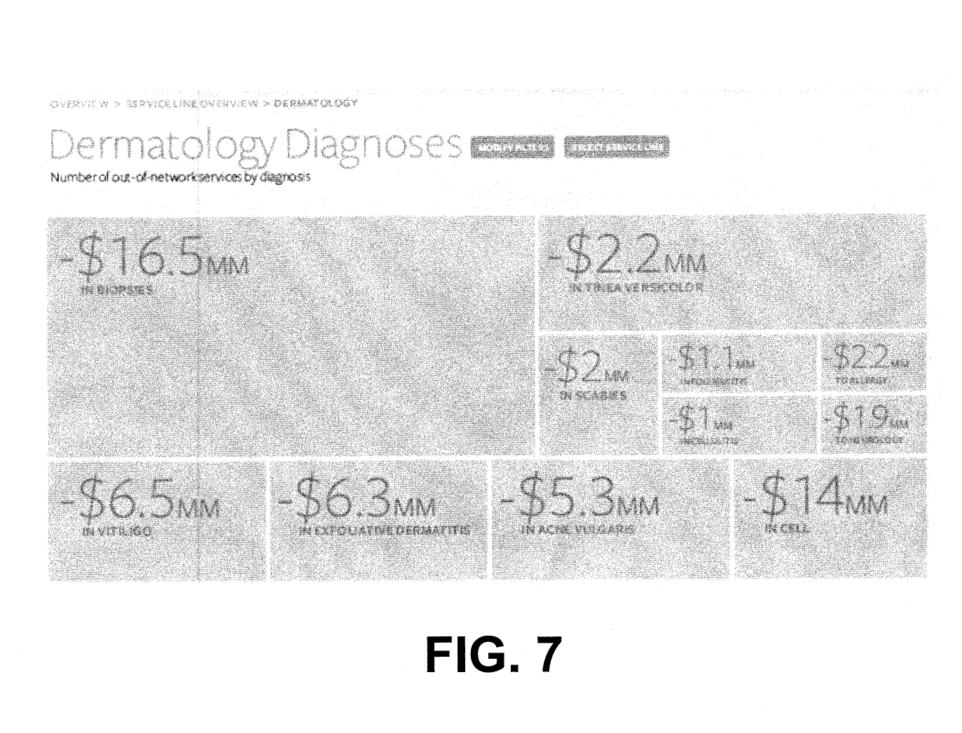

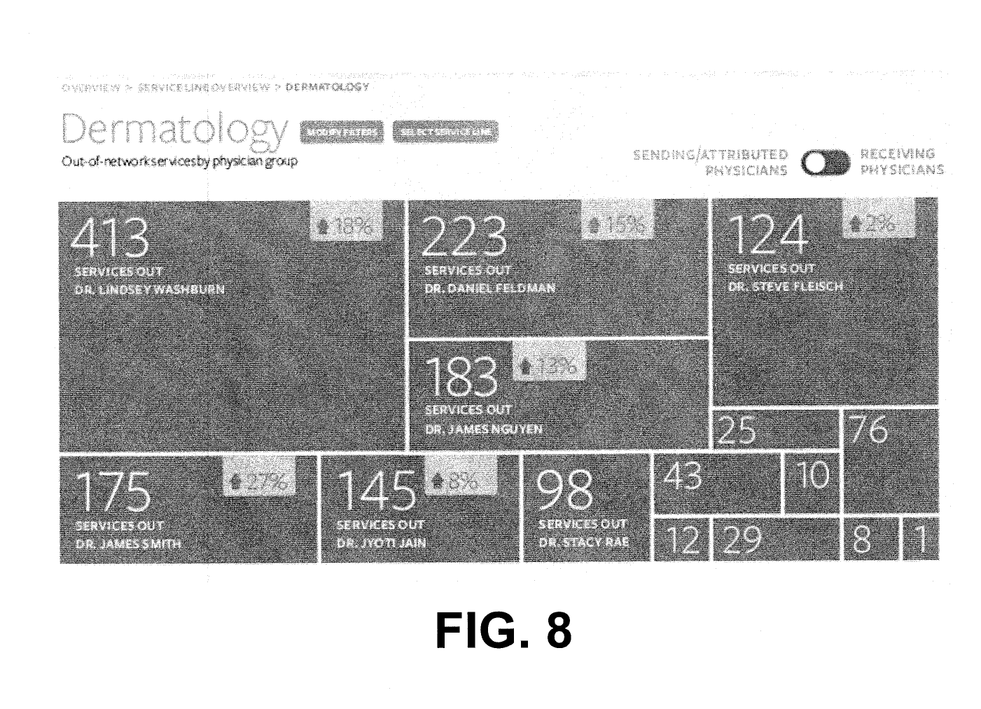

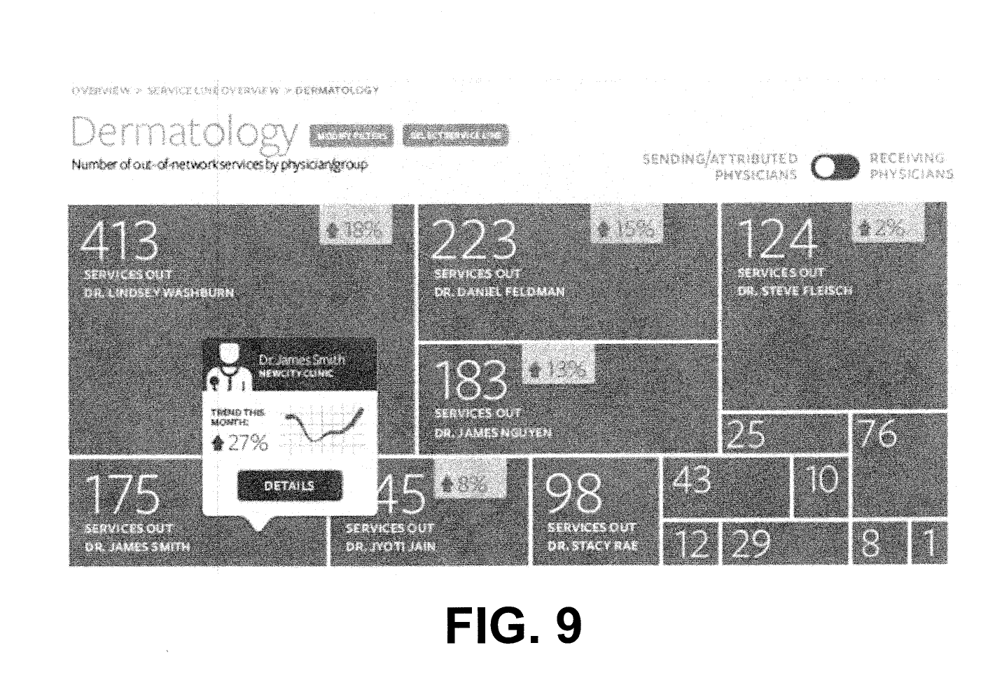

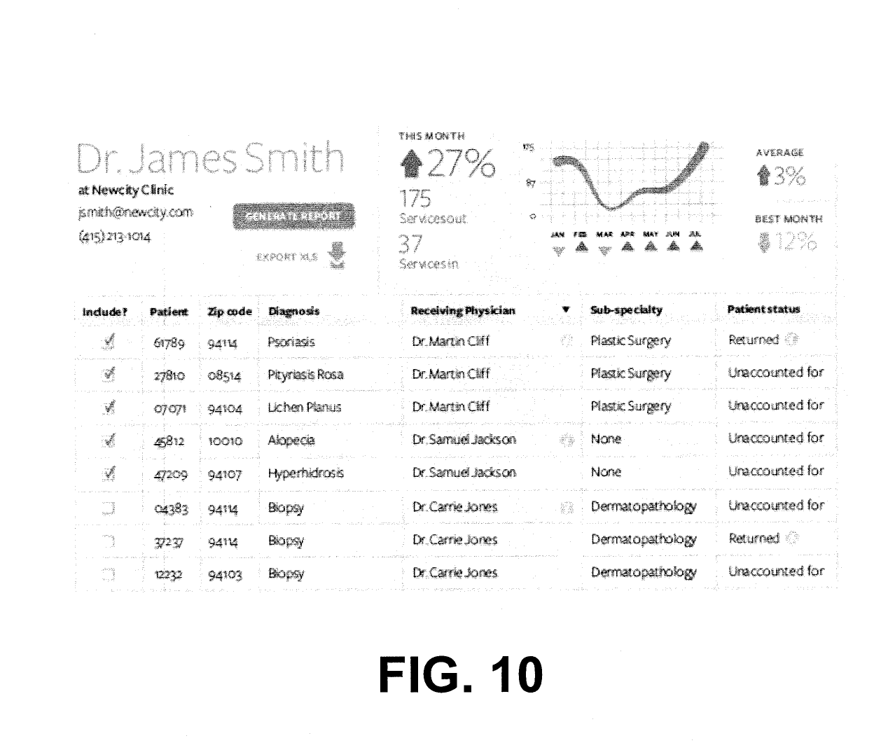

FIGS. 7 and 8 provide exemplary “Diagnoses” and “Physicians” screens based on the “Diagnoses” and “Physicians” buttons shown in FIG. 6, respectively. The exemplary “Diagnoses” screen provides an even more detailed procedure-related breakdown, providing specific information regarding how much of the $41MM lost due to out-of-network utilization were attributable to each of a plurality of diagnoses (e.g., biopsies, vitiligio, tinea versicolor, etc.). Similarly, the exemplary “Physicians” screen provides a physician-based breakdown within the context of Dermatology, providing specific information regarding how many of the 7,073 out-of-network services were attributable to each of a plurality of physicians. These further “Diagnoses” and “Physicians” screens also provide filtering options (similar to as discussed above with respect to FIG. 5), and further include additional options for obtaining even more detailed information. For example, FIGS. 9 and 10 illustrate screens corresponding to even more specific information obtained with respect to a specific doctor appearing on the “Physicians” screen of FIG. 8, including trend information and specific claim information. FIG. 10 further shows that the user has the option to generate a report document in another format (e.g., for printing) or exporting the data to a spreadsheet (“Export xls”). FIGS. 8 and 9 further include the option to toggle between viewing data pertaining to in-network “sending/attributed physicians” and viewing data pertaining to out-of-network “receiving physicians” corresponding to the detailed out-of-network utilization information.

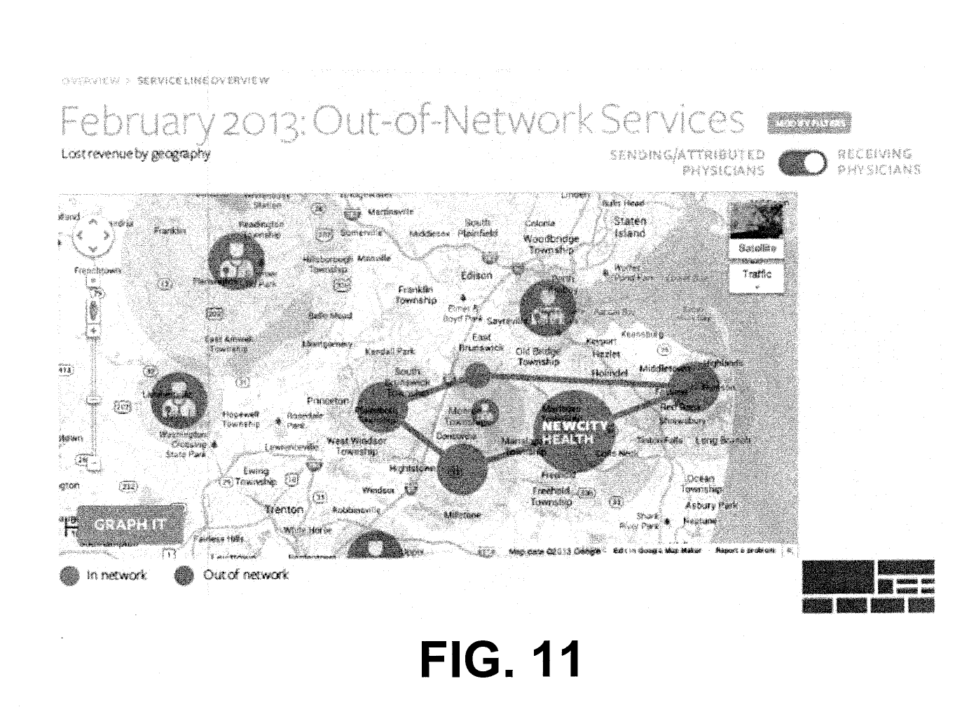

FIG. 11 illustrates an exemplary screen that shows an alternative, map-based report for displaying geographic information relating to out-of-network utilization. In the example depicted by FIG. 11, the “Newcity Health” network is indicated by the 5 joined circular areas, while out-of-network physicians receiving patients under the “Newcity Health” network are indicated by the other circular areas with physician icons. This screen thus provides a convenient way for a user to ascertain the amount and/or value of out-of-network services being provided by out-of-network physicians in different geographic areas (the greater the radius, the larger the amount and/or value of services performed). The screen further includes various interactive options, such as the ability to apply filters, or to change the report format to a graphical or square-based view. The screen in FIG. 11 further includes the option to toggle between viewing the geographic locations of “sending/attributed physicians” versus “receiving physicians” (e.g., to ascertain where both in-network and out-of-network receiving physicians are located, as well as where both in-network and out-of-network sending physicians are located—with in-network and out-of-network physicians being distinguished in both display options, for example, by color).

It will be appreciated that the screens depicted in FIGS. 5-11 are merely examples, and that the information capable of being reported and the manners in which the information may be reported by various embodiments of the invention are not limited to the exemplary screens of FIGS. 5-11.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A patient out-of-network utilization analysis and reporting system, comprising:
an out-of-network utilization analysis server, configured to access one or more databases to obtain healthcare claims information, to generate out-of-network utilization analysis information corresponding to identification of potential sources of patient out-of-network utilization based on the obtained healthcare claims information, and to the send out-of-network utilization analysis information to a client computing device, wherein the healthcare claims information includes procedure-related information; and
the client computing device, configured to receive out-of-network utilization analysis information via a network from a server and to display the out-of-network utilization analysis information to a user of the client computing device.

2. The system according to claim 1, wherein generating the out-of-network utilization analysis information includes a determination of whether a procedure or procedure category is available in-network based on the procedure-related information.

3. The system according to claim 2, wherein the determination of whether a procedure or procedure category is based on a number of claims corresponding to the procedure or procedure category performed in-network being greater than a threshold.

4. The system according to claim 2, wherein the determination of whether a procedure or procedure category is based on a ratio of claims corresponding to the procedure or procedure category performed in-network relative to claims corresponding to the procedure or procedure category performed out-of-network or to total claims corresponding to the procedure or procedure category being greater than a threshold.

5. The system according to claim 1, wherein the client computing device is further configured to provide a user input interface for manipulation of the display of the out-of-network utilization analysis information.

6. The system according to claim 5, wherein the user input interface includes an option for a user to apply filters to displayed out-of-network utilization analysis information.

7. The system according to claim 1, wherein the out-of-network utilization analysis server is further configured to identify one or more trends corresponding to patient out-of-network utilization.

8. The system according to claim 7, wherein the one or more trends include an increase in patient out-of-network utilization over a period of time for a particular procedure or procedure category.

9. The system according to claim 1, wherein the out-of-network utilization analysis server is further configured to generate one or more alerts based on one or more conditions relating to patient out-of-network utilization.

10. The system according to claim 1, wherein the out-of-network utilization analysis information includes information relating to out-of-network healthcare providers that have provided healthcare services to in-network patients.

11. A patient out-of-network utilization analysis and reporting system, comprising:
an out-of-network utilization analysis server, configured to access one or more databases to obtain healthcare claims information, to generate out-of-network utilization analysis information corresponding to identification of potential sources of patient out-of-network utilization based on the obtained healthcare claims information, and to send the out-of-network utilization analysis information to a client computing device, wherein the healthcare claims information includes physician attribution information; and
the client computing device, configured to receive out-of-network utilization analysis information via a network from a server and to display the out-of-network utilization analysis information to a user of the client computing device.

12. The system according to claim 11, wherein the identification of potential sources of patient out-of-network utilization includes identification of in-network physicians associated with patient out-of-network utilization.

13. The system according to claim 12, wherein in-network physicians are identified as being associated with patient out-of-network utilization based on an number or amount of patients corresponding to an in-network physician going out-of-network for healthcare services exceeding a threshold number, ratio or percentage.

14. The system according to claim 13, wherein instances of patients going out-of-network for healthcare services with respect to healthcare services determined by the server as being unavailable in-network are excluded from the number or amount of patients corresponding to the in-network physician going out-of-network for healthcare services.

15. The system according to claim 11, wherein the client computing device is further configured to provide a user input interface for manipulation of the display of the out-of-network utilization analysis information.

16. The system according to claim 11, wherein the user input interface includes an option for a user to apply filters to displayed out-of-network utilization analysis information.

17. The system according to claim 11, wherein the out-of-network utilization analysis server is further configured to identify one or more trends corresponding to patient out-of-network utilization.

18. The system according to claim 17, wherein the one or more trends include an increase in patient out-of-network utilization over a period of time corresponding to a particular physician or group of physicians.

19. The system according to claim 11, wherein the out-of-network utilization analysis server is further configured to generate one or more alerts based on one or more conditions relating to patient out-of-network utilization.

20. The system according to claim 11, wherein the out-of-network utilization analysis information includes information relating to out-of-network healthcare providers that have provided healthcare services to in-network patients.

21. A non-transitory, processor-readable medium having processor-executable instructions stored thereon for patient out-of-network utilization analysis, the processor-executable instructions comprising instructions for:
obtaining healthcare claims information from one or more databases, wherein the healthcare claims information includes at least one of the group consisting of: procedure-related information and physician attribution information;
generating out-of-network utilization analysis information corresponding to identification of potential sources of patient out-of-network utilization based on the obtained healthcare claims information; and
sending the out-of-network utilization analysis information to a user computing device.

22. The non-transitory processor-readable medium according to claim 21, wherein generating the out-of-network utilization analysis information further comprises:
determination whether one or more procedures or procedure categories is available in-network based on the procedure-related information.

23. The non-transitory processor-readable medium according to claim 21, wherein the out-of-network utilization analysis information includes information relating to out-of-network healthcare providers that have provided healthcare services to in-network patients.
